(19) United States
(12) Patent Application Publication
(10) Pub. No.: US 2021/0300332 A1
(43) Pub. Date: Sep. 30, 2021

(54) VEHICLE CONTROL SYSTEM

(71) Applicant: HONDA MOTOR CO., LTD., Tokyo (JP)

(72) Inventors: Kentaro KASUYA, Saitama (JP); Hiroyuki TOKUNAGA, Saitama (JP)

(21) Appl. No.: 17/209,447

(22) Filed: Mar. 23, 2021

(30) Foreign Application Priority Data
Mar. 27, 2020 (JP) 2020-057829

(51) Int. Cl. B60W 30/02; B60W 10/20; B60W 10/18; B60W 40/06

(52) U.S. Cl. CPC B60W 30/02; B60W 10/20; B60W 2552/53; B60W 40/06; B60W 10/18

(57) ABSTRACT

A vehicle control system, includes: a travel control unit configured to generate a first control signal for controlling a direction control device of a vehicle to make the vehicle travel along a road shape; a stability control unit configured to generate a second control signal for controlling the direction control device to stabilize behavior of the vehicle when the behavior of the vehicle is in a prescribed unstable state; and an arbitration unit configured to receive the first control signal and the second control signal and to output at least one of the first control signal and the second control signal to the direction control device. When the arbitration unit is receiving the second control signal, the arbitration unit reduces a control amount corresponding to the first control signal.

### TECHNICAL FIELD

The present invention relates to a vehicle control system.

### BACKGROUND ART

JP2017-165184A discloses a travel control device configured to make a vehicle travel autonomously along a road shape and a lane by automatically controlling the acceleration/deceleration and the steering of the vehicle. Also, JP2010-89540A discloses an electric power steering device in which, when the vehicle is traveling on a split μ road and is deviating in a direction toward the high μ road surface side, a target current for the assist motor is corrected to turn the steering wheel in the direction toward the low μ road surface side, so that irregular vehicle behavior caused by the split μ road is suppressed.

When the travel assist control for making the vehicle travel along the road shape and the stability control for stabilizing the vehicle behavior are executed independently, the stability control may cause actual behavior of the vehicle to deviate from the target behavior of the travel assist control. In this case, the travel assist control may generate an erroneous control amount in an attempt to make the actual behavior of the vehicle match the target behavior.

### SUMMARY OF THE INVENTION

In view of the foregoing background, an object of the present invention is to provide a vehicle control system which can execute the travel control for making the vehicle travel along a road shape and the stability control in coordination.

### Means to Accomplish the Task

To achieve the above object, one embodiment of the present invention provides a vehicle control system (1), comprising: a travel control unit (43) configured to generate a first control signal for controlling a direction control device (4, 5) of a vehicle to make the vehicle travel along a road shape; a stability control unit (36) configured to generate a second control signal for controlling the direction control device to stabilize behavior of the vehicle when the behavior of the vehicle is in a prescribed unstable state; and an arbitration unit (37) configured to receive the first control signal and the second control signal and to output at least one of the first control signal and the second control signal to the direction control device, wherein the arbitration unit reduces a control amount corresponding to the first control signal while receiving the second control signal,

According to this configuration, when the second control signal is being generated, the direction control device can reduce the control amount corresponding to the first control signal, thereby to prioritize the stability control. Thus, the travel control and the stability control can be made can be executed in coordination.

In the above configuration, preferably, the travel control unit does not acquire motion state information of the vehicle while the arbitration unit is receiving the second control signal. Also preferably, the travel control unit does not generate the first control signal when the arbitration unit is receiving the second control signal.

According to this configuration, it is possible to prevent the first control signal generated by the travel control unit from influencing the motion state occurring as a result of the stability control.

In the above configuration, preferably, while the arbitration unit is receiving the second control signal, the travel control unit estimates motion state information after the direction control device is driven based on the second control signal and generates the first control signal based on estimated motion state information.

According to this configuration, when the second control signal disappears, the travel control unit can resume output of the first control signal promptly.

In the above configuration, preferably, the arbitration unit does not output the first control signal to the direction control device while receiving the second control signal.

According to this configuration, when the second control signal is being generated, the direction control device does not execute control based on the first control signal. Thus, the travel assist control and the stability control can be executed in coordination.

In the above configuration, preferably, the direction control device includes at least one of a steering device (5) and a brake device (4) provided for each of left and right wheels.

According to the foregoing configuration, it is possible to provide a vehicle control system that can execute the travel control for making the vehicle travel along a road shape and the stability control in coordination.

### BRIEF DESCRIPTION OF THE DRAWINGS

FIG. 1 is a functional configuration diagram of a vehicle in which a vehicle control system is installed;

FIG. 2 is a flowchart showing the procedure of the process performed by travel control unit;

FIG. 3 is a flowchart showing the procedure of the process performed by a stability control unit; and

FIG. 4 is flowchart showing the procedure of the process performed by an arbitration unit.

### DESCRIPTION OF THE PREFERRED EMBODIMENT(S)

In the following, an embodiment of a vehicle control system according to the present invention will be described with reference to the drawings.

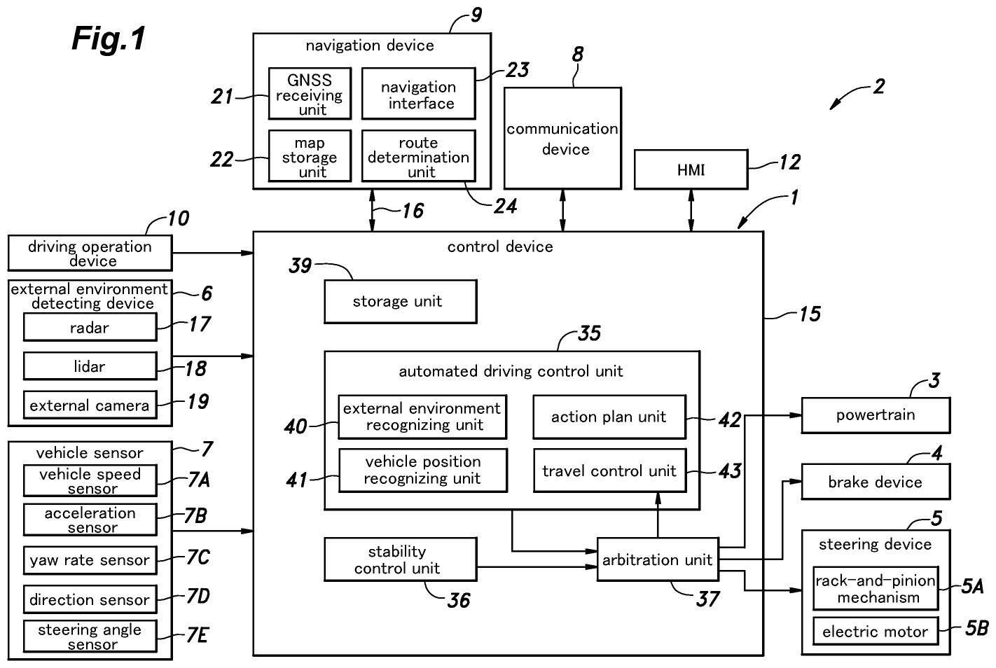

As shown in FIG. 1, a vehicle control system 1 according to the embodiment of the present invention is included in a vehicle system 2 installed in a vehicle. The vehicle system 2 includes a powertrain 3, a brake device 4, a steering device 5, an external environment detecting device 6, a vehicle sensor 7, a communication device 8, a navigation device 9 (map device), a driving operation device 10, an occupant monitoring device 11, a human machine interface (HMI) 12, and a control device 15. The above components of the vehicle system 2 are connected to each other so that signals can be transmitted therebetween via communication means such as a Controller Area Network (CAN) 16. In the present embodiment, the control device 15 embodies the vehicle control system 1.

The powertrain 3 is a device configured to apply a driving force to the vehicle. The powertrain 3 includes a power source and a transmission, for example. The power source includes at least one of an internal combustion engine, such as a gasoline engine and a diesel engine, and an electric motor. The brake device 4 is a device configured to apply a brake force to the vehicle. For example, the brake device 4 includes a brake caliper configured to press a brake pad against a brake rotor and an electric cylinder configured to supply an oil pressure to the brake caliper. The brake device 4 may include a parking brake device configured to restrict rotations of the wheels via wire cables. The steering device 5 is a device for changing a steering angle of the wheels. For example, the steering device 5 includes a rack-and-pinion mechanism 5A configured to steer (turn) the wheels and an electric motor 5B configured to drive the rack-and-pinion mechanism 5A. The powertrain 3, the brake device 4, and the steering device 5 are controlled by the control device 15.

The external environment detecting device 6 is a device for detecting objects outside the vehicle and the like. The external environment detecting device 6 includes sensors for detecting electromagnetic waves such as visible light from the surroundings of the vehicle to detect objects outside the vehicle and the like. Such sensors may include, for example, one or more radars 17, one or more lidars 18, and one or more external cameras 19. Besides, the external environment detecting device 6 may include a device configured to receive signals from outside the vehicle and to detect objects outside the vehicle based on the received signals. The external environment detecting device 6 outputs a detection result to the control device 15.

Each radar 17 emits radio waves such as millimeter waves to the surroundings of the vehicle and captures the radio waves reflected by an object around the vehicle thereby to detect the position (distance and direction) of the object. Each radar 17 may be mounted at any suitable position on the vehicle. The one or more radars 17 preferably include at least a front radar configured to emit radio waves in the forward direction of the vehicle, a rear radar configured to emit radio waves in the rearward direction of the vehicle, and a pair of left and right side radars configured to emit radio waves in the left and right directions of the vehicle.

Each lidar 18 emits light such as infrared light to the surroundings of the vehicle and captures the light reflected by an object around the vehicle thereby to detect the position (distance and direction) of the object. Each lidar 18 may be mounted at any suitable position on the vehicle.

The one or more external cameras 19 are arranged to capture images of the surroundings of the vehicle to detect objects around the vehicle, for example, nearby vehicles and pedestrians, guardrails, curbs, walls, median strips, and road markings used on the road surface to convey various information such as lane boundaries and road shapes. Each external camera 19 may consist of a digital camera using a solid imaging element such as a CCD or a CMOS, for example. Each external camera 19 may be mounted at any suitable position on the vehicle. The one or more external cameras 19 include at least a front camera for capturing images in front of the vehicle. Preferably, the one or more external cameras 19 further include a rear camera configured to capture images behind the vehicle and a pair of side cameras configured to capture images on left and right sides of the vehicle. Each external camera 19 may be a stereo camera, for example.

The vehicle sensor 7 includes a vehicle speed sensor 7A configured to detect the speed of the vehicle, an acceleration sensor 7B configured to detect the acceleration of the vehicle, a yaw rate sensor 7C configured to detect the angular velocity around a vertical axis of the vehicle, and a direction sensor 7D configured to detect the direction of the vehicle. The yaw rate sensor 7C consists of a gyro sensor, for example.

The communication device 8 enables the control device 15 to communicate with the navigation device 9, vehicles present around the own vehicle, and/or an outside server. The control device 15 can communicate wirelessly with the vehicles around the own vehicle via the communication device 8. Further, the control device 15 can communicate with a server providing traffic control information and the like via the communication device 8. The control device 15 can also communicate with mobile terminals carried by persons outside the vehicle via the communication device 8. In addition, the control device 15 can communicate with an emergency communications center which receives an emergency message from the vehicle via the communication device 8.

The navigation device 9 is a device configured to obtain a current position of the vehicle and provides route guidance to a destination and the like. The navigation device 9 includes a GNSS receiving unit 21, a map storage unit 22, a navigation interface 23, and a route determination unit 24. The GNSS receiving unit 21 identifies the position (latitude and longitude) of the vehicle based on a signal received from an artificial satellite (positioning satellite). The map storage unit 22 consists of a known storage device such as a flash memory or a hard disk, and stores map information.

The navigation interface 23 is configured to receive an input, such as the destination, from the occupant and to present various kinds of information by display and/or voice. The navigation interface 23 preferably includes, for example, a touch panel display, a speaker, and the like. In another embodiment, the GNSS receiving unit 21 may be configured as a part of the communication device 8. Also, the map storage unit 22 may be configured as a part of the control device 15 or a part of a server device that can communicate with the control device 15 via the communication device 8.

The map information preferably contains types of roads such as expressways, toll roads, national highways, and prefectural roads, the number of lanes in each road, the center position of each lane (three-dimensional coordinate including a longitude, a latitude, and a height), shapes of the road markings such as road delimiting lines and lane boundaries, presence/absence of sidewalks, curbs, fences and the like, positions of intersections, positions of lane-merging points and lane-branching points, areas of emergency parking zones, and road information such as width of each lane and road signs on the roads. The map information may also contain traffic control information, address information (address, postal code), facility information, telephone number information, and so on.

The route determination unit 24 determines the route to the destination based on the position of the vehicle identified by the GNSS receiving unit 21, the destination input via the navigation interface 23, and the map information. Also, when determining the route, the route determination unit 24 preferably determines the target lane, which is a lane to be traveled by the vehicle, by referring to the positions of the lane-merging points and the lane-branching points contained in the map information.

The driving operation device 10 is configured to receive an input operation performed by the driver to control the vehicle. The driving operation device 10 includes, for example, a steering wheel, an accelerator pedal, and a brake pedal.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

As shown in FIG. 1, the control device 15 includes an automated driving control unit 35, a stability control unit 36, an arbitration unit 37, and a storage unit 39.

The automated driving control unit 35 includes an external environment recognizing unit 40, a vehicle position recognizing unit 41, an action plan unit 42, and a travel control unit 43. The external environment recognizing unit 40 recognizes, based on the detection result of the external environment detecting device 6, obstacles around the vehicle, road shape, presence or absence of sidewalks, and road markings. The obstacles include, for example, guardrails, utility poles, nearby vehicles, and persons such as pedestrians. The external environment recognizing unit 40 can acquire a state of each nearby vehicle, such as the position, speed, and acceleration from the detection result of the external environment detecting device 6. The position of the nearby vehicle may be recognized as a position of a representative point of the nearby vehicle such as the center of gravity or a corner part of the nearby vehicle, or as an area represented by the contour of the nearby vehicle.

The vehicle position recognizing unit 41 recognizes a travel lane, which is the lane on which the vehicle is traveling, and the position and angle of the vehicle relative to the travel lane. For example, the vehicle position recognizing unit 41 may recognize the travel lane based on the map information stored in the map storage unit 22 and the position of the vehicle acquired by the GNSS receiving unit 21. Also, the vehicle position recognizing unit 41 may recognize the position and angle of the vehicle relative to the travel lane by extracting the delimiting lines provided on the road surface around the vehicle from the map information and comparing the shape of the extracted delimiting lines with the shape of the delimiting lines image-captured by the external camera 19.

The action plan unit 42 sequentially creates an action plan for making the vehicle travel along the route. More specifically, the action plan unit 42 first determines events for making the vehicle travel in the target lane determined by the route determination unit 24 such that the vehicle does not contact obstacles. The events may include, for example, a constant speed travel event in which the vehicle is caused to travel in the same travel lane at a constant speed, a following travel event in which the vehicle is caused to follow a preceding vehicle traveling in the same travel lane at a speed less than or equal to a set speed set by the occupant or a speed determined based on the environment in which the vehicle is traveling, a lane change event in which the vehicle is caused to change the travel lane thereof, an overtaking event in which the vehicle is caused to overtake a preceding vehicle, a merging event in which the vehicle is caused to merge at a merging point of the road, a branching event in which the vehicle is caused to travel in a target direction at a branching point of the road, an automated driving termination event in which the automated driving is terminated and switched to manual driving, and a vehicle stop event in which the vehicle is caused to stop when, during travel of the vehicle, a prescribed condition indicating that it is difficult for the control device 15 or the driver to continue driving is satisfied.

During execution of these events, the action plan unit 42 may determine an avoidance event to avoid obstacles or the like based on situations near the vehicle (the presence of nearby vehicles and pedestrians, lane narrowing due to road construction, and the like).

The action plan unit 42 further generates a target trajectory along which the vehicle should travel in the future based on the determined events. The target trajectory is generated as a set of trajectory points arranged in order, where the trajectory points are points that the vehicle should reach at respective future times. Preferably, the action plan unit 42 generates the target trajectory based on a target speed and a target acceleration set for each event. Here, the information of the target speed and the target acceleration is represented by the intervals between the trajectory points.

The travel control unit 43 controls the powertrain 3, the brake device 4, and the steering device 5 such that the vehicle travels along the target trajectory generated by the action plan unit 42 on time as planned. For example, in the constant speed travel event and the following travel event, the travel control unit 43 generates a first control signal for controlling a direction control device to make the vehicle travel along the target trajectory generated along the road shape. The road shape is determined mainly by the shape of the lane. The direction control device includes at least one of the steering device 5 and the brake device 4. In the present embodiment, the steering device 5 is used as the direction control device, and the brake device 4 is used for deceleration.

For example, the travel control unit 43 acquires the difference between the target trajectory and the direction of the own vehicle based on the images captured by the external camera 19, and sets a first steering angle control amount based on the acquired difference. The first control signal includes the first steering angle control amount. In another embodiment, the travel control unit 43 may set the first steering angle control amount based on the current position, an extension direction of the lane at the current position included in the map information, and the direction of the vehicle. Besides, the travel control unit 43 may set the first steering angle control amount by any of various known methods to make the vehicle travel along the lane.

The stability control unit 36 generates a second control signal for controlling the direction control device to stabilize the behavior of the vehicle when the behavior of the vehicle is in a prescribed unstable state. In the present embodiment, the direction control device is the steering device 5. The stability control unit 36 sets the second control signal, which is a control amount of the steering device 5, to suppress oversteer and understeer of the vehicle and to stabilize the vehicle on a split μ road. The prescribed unstable state of the behavior of the vehicle includes at least one of a state in which the vehicle is oversteered, a state in which the vehicle is understeered, and a state in which the vehicle is traveling on a split μ road. A split μ road has different friction coefficients (μ) on the surfaces traveled by the left and right wheels of the vehicle, respectively.

For example, to suppress the oversteer and understeer of the vehicle, the stability control unit 36 determines whether or not the vehicle is in the oversteer state or the understeer state, and when the vehicle is in the oversteer state or the understeer state, sets a steering amount for suppressing the oversteer or understeer. For example, the stability control unit 36 may calculate a reference yaw rate based on the vehicle speed acquired by the vehicle speed sensor 7A and the steering angle acquired by the steering angle sensor 7E, and determine whether or not the vehicle is in the oversteer state or the understeer state based on the difference between the calculated yaw rate and the actual yaw rate acquired by the yaw rate sensor 7C. The stability control unit 36 may set the steering amount for suppressing the oversteer and understeer as a second steering angle control amount, based on the difference between the reference yaw rate and the actual yaw rate.

Also, to stabilize the vehicle on a split μ road, the stability control unit 36 may determine whether the vehicle is traveling on a split μ road based on the difference between the left and right wheel speeds, and when it is determined that the vehicle is traveling on a split μ road, set the steering amount for suppressing the yaw rate caused due to the split μ road as the second steering angle control amount. It may be determined that the vehicle is traveling on a split μ road when the difference between the left and right wheel speeds is greater than or equal to a prescribed value. When the vehicle is traveling on a split μ road, the vehicle can easily deviate toward the high μ road surface side, and therefore, the second steering angle control amount is set so as to steer the vehicle toward the low μ road surface side. The second steering angle control amount is preferably set such that the absolute value thereof becomes larger as the difference between the left and right wheel speeds becomes larger.

The first control signal generated by the travel control unit 43 and the second control signal generated by the stability control unit 36 are input to the arbitration unit 37. The arbitration unit 37 outputs at least one of the first control signal and the second control signal to the steering device 5 serving as the direction control device. The arbitration unit 37 reduces the control amount corresponding to the first control signal while receiving the second control signal.

For example, the arbitration unit 37 may correct the first control signal and the second control signal by multiplying them by respective gains and output the corrected values of the first control signal and the second control signal to the steering device 5. The arbitration unit 37 preferably calculates the corrected values of the first control signal and the second control signal so as to prioritize the second control signal over the first control signal while receiving the second control signal. For example, while receiving the second control signal, the arbitration unit 37 may multiply the second control signal by a gain of 1 and the first control signal by a gain of 0 and output only the second control signal to the steering device 5. Also, while receiving the second control signal, the arbitration unit 37 may multiply the second control signal by a gain of 1 and the first control signal by a gain greater than 0 and less than 1, add the steering angle control amount corresponding to the calculated second control signal and the steering angle control amount corresponding to the calculated first control signal, and output the result of the addition to the steering device 5. Due to such operation of the arbitration unit 37, the steering device 5 is mainly controlled based on the second control signal and the influence of the first control signal on the steering device 5 is reduced.

While receiving the second control signal, the arbitration unit 37 outputs a control stop signal to the travel control unit 43. The travel control unit 43 stops outputting the first control signal to the arbitration unit 37 while receiving the control stop signal. For example, the travel control unit 43 may be configured not to acquire motion state information of the vehicle while receiving the control stop signal. The motion state information of the vehicle includes the vehicle speed, acceleration (fore and aft acceleration, lateral acceleration), yaw rate, direction, steering angle, the fluid pressure of the brake device 4, and so on. Thereby, the travel control unit 43 becomes unable to generate the first control signal. Also, the travel control unit 43 may be configured to acquire the motion state information of the vehicle but does not generate the first control signal while receiving the control stop signal. Further, the travel control unit 43 may be configured to generate the first control signal but does not output the generated first control signal to the arbitration unit 37 while receiving the control stop signal.

When the control stop signal disappears due to disappearance of the second control signal, the travel control unit 43 may resume generation of the first control signal. In another embodiment, while receiving the control stop signal, the travel control unit 43 may estimate the motion state information after the steering device 5 serving as the direction control device is driven based on the second control signal and generate the first control signal based on the estimated motion state information. The motion state information after the steering device 5 is driven based on the second control signal is the motion state information after the behavior of the vehicle is stabilized. For example, the estimated motion state information may include the yaw rate and the steering angle. The estimated yaw rate preferably is the yaw rate calculated by the stability control unit 36, for example. The estimated steering angle preferably is a sum of the actual steering angle and the second steering angle control amount.

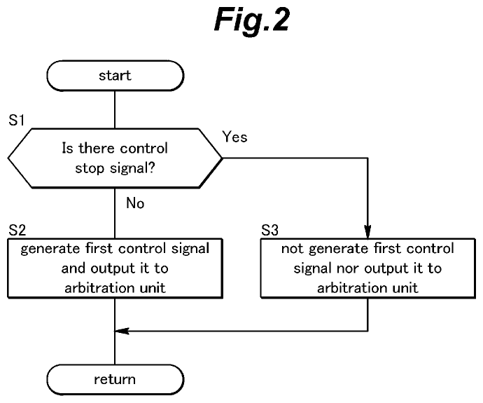

Description will now be made of one example of the control procedure for the steering device 5 executed by the control device 15. The travel control unit 43 executes the process shown in FIG. 2 repeatedly at a prescribed time interval T1. The travel control unit 43 first determines whether the control stop signal is being received (S1). When it is determined that the control stop signal is not being received (the determination result in S1 is No), the travel control unit 43 generates the first control signal containing the first steering angle control amount for controlling the steering device 5 and outputs the first control signal to the arbitration unit 37 to make the vehicle travel along the target trajectory generated along the lane (S2). When it is determined that the control stop signal is being received (the determination result in S1 is Yes), the travel control unit 43 does not generate the first control signal and does not output the first control signal to the arbitration unit 37 (S3). After executing the processes of steps S2 and S3, the travel control unit 43 executes the process shown in FIG. 2 again from step S1.

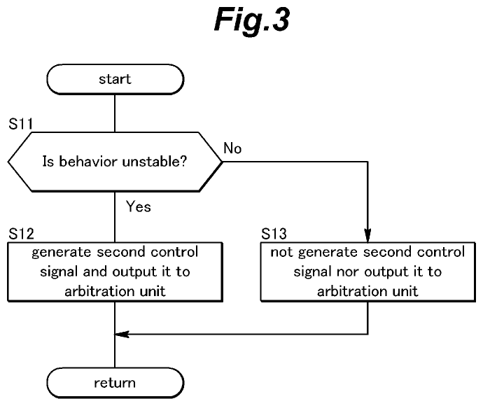

The stability control unit 36 executes the process shown in FIG. 3 repeatedly at a prescribed time interval T2. The time interval T2 for the process executed by the stability control unit 36 is set to be shorter than the time interval T1 for the process executed by the travel control unit 43. The stability control unit 36 first determines whether the behavior of the vehicle is in the prescribed unstable state (S11). As described above, the prescribed unstable state includes at least one of the state in which the vehicle is oversteered, the state in which the vehicle is understeered, and the state in which the vehicle is traveling on a split μ road. The stability control unit 36 calculates the reference yaw rate based on the vehicle speed acquired by the vehicle speed sensor 7A and the steering angle acquired by the steering angle sensor 7E, and makes the determination on the oversteer state and the understeer state based on the difference between the calculated yaw rate and the actual yaw rate acquired by the yaw rate sensor 7C. Also, it is determined that the vehicle is traveling on a split μ road when the difference between the left and right wheel speeds is greater than or equal to a prescribed value.

When it is determined that the behavior of the vehicle is in the prescribed unstable state (the determination result in S11 is Yes), the stability control unit 36 generates the second control signal containing the second steering angle control amount for stabilizing the behavior of the vehicle, and outputs the second control signal to the arbitration unit 37 (S12). To suppress the oversteer and understeer, the stability control unit 36 preferably calculates the second steering angle control amount based on the difference between the reference yaw rate and the actual yaw rate. Also, to stabilize the behavior of the vehicle on a split μ road, the stability control unit 36 may calculate the second steering angle control amount based on the difference between the left and right wheel speeds.

When it is determined that the behavior of the vehicle is not in the prescribed unstable state (the determination result in S11 is No), the stability control unit 36 does not generate the second control signal and does not output the second control signal to the arbitration unit 37 (S13). After executing the process in steps S12 and S13, the stability control unit 36 executes the process shown in FIG. 3 again from step S11.

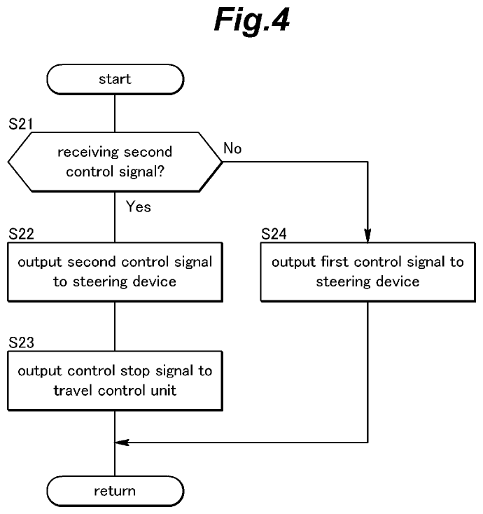

The arbitration unit 37 executes the process shown in FIG. 4 repeatedly at a prescribed time interval T3. The time interval T3 may be the same as the time interval T2 for the process executed by the stability control unit 36. The arbitration unit 37 first determines whether it is receiving the second control signal (S21). When it is determined that the arbitration unit 37 is receiving the second control signal (the determination result in S21 is Yes), the arbitration unit 37 outputs the second control signal to the steering device 5 (S22). Accordingly, the steering device 5 changes the steering angle based on the second control signal to stabilize the behavior of the vehicle. Also, the arbitration unit 37 outputs the control stop signal to the travel control unit 43 (S23). As a result of receipt of the control stop signal, the travel control unit 43 determines that the determination result in step S1 is Yes.

When it is determined that the arbitration unit 37 is not receiving the second control signal (the determination result in S21 is No), the arbitration unit 37 outputs the first control signal to the steering device 5 (S24). Accordingly, the steering device 5 changes the steering angle based on the first control signal to make the vehicle travel along the lane. After executing the process of steps S23 and S24, the arbitration unit 37 executes the process shown in FIG. 4 from step S21.

In the foregoing vehicle control system 1, while the second control signal is being generated, the steering device 5 can reduce the control amount corresponding to the first control signal, thereby to prioritize the stability control. Thus, the travel control and the stability control can be executed in coordination. Particularly, while the second control signal is being generated, the vehicle control system 1 stops the control based on the first control signal and controls the steering device 5 based on only the second control signal, whereby the behavior of the vehicle becomes stable.

Concrete embodiments have been described in the foregoing, but the present invention is not limited to the above embodiments and may be modified or altered in various ways. For example, instead of the steering device 5, the brake device 4 may be used as the direction control device of the vehicle. In this case, the stability control unit 36 preferably sets a brake fluid pressure for causing the brake device 4 to generate a braking force difference corresponding to the second steering angle control amount, and the travel control unit 43 preferably sets a brake fluid pressure for causing the brake device 4 to generate a braking force difference corresponding to the first steering angle control amount.

Also, the stability control unit 36 may set the control amount of the powertrain 3 to stabilize the behavior of the vehicle (namely, the powertrain 3 may be used as the direction control device). Similarly to the case where the steering device 5 is used as the direction control device, in the cases where the brake device 4 is used as the direction control device and where the powertrain 3 is used as the direction control device also, the arbitration unit 37 may reduce the control amount corresponding to the first control signal generated by the travel control unit 43 to reduce the influence of the travel control on the stability control so that the travel control and the stability control are executed in coordination.

In the above embodiment, the travel control unit 43 is configured as a part of the automated driving control unit 35 for performing the automated driving, but in another embodiment, the travel control unit 43 may be configured as a control unit implementing only the lane keeping function.

1. A vehicle control system, comprising:
a travel control unit configured to generate a first control signal for controlling a direction control device of a vehicle to make the vehicle travel along a road shape;
a stability control unit configured to generate a second control signal for controlling the direction control device to stabilize behavior of the vehicle when the behavior of the vehicle is in a prescribed unstable state; and
an arbitration unit configured to receive the first control signal and the second control signal and to output at least one of the first control signal and the second control signal to the direction control device,
wherein the arbitration unit reduces a control amount corresponding to the first control signal while receiving the second control signal.

2. The vehicle control system according to claim 1, wherein the travel control unit does not acquire motion state information of the vehicle while the arbitration unit is receiving the second control signal.

3. The vehicle control system according to claim 1, wherein the travel control unit does not generate the first control signal while the arbitration unit is receiving the second control signal.

4. The vehicle control system according to claim 1, wherein while the arbitration unit is receiving the second control signal, the travel control unit estimates motion state information after the direction control device is driven based on the second control signal and generates the first control signal based on estimated motion state information.

5. The vehicle control system according to claim 1, wherein the arbitration unit does not output the first control signal to the direction control device while receiving the second control signal.

6. The vehicle control system according to claim 1, wherein the direction control device includes at least one of a steering device and a brake device provided for each of left and right wheels.
